(19) United States
(12) Patent Application Publication
(10) Pub. No.: US 2025/0136412 A1
(43) Pub. Date: May 1, 2025

(54) ELONGATED RAMP IN LIFTING SYSTEM FOR A STAIRWAY

(71) Applicant: LIFTUP A/S, Støvring (DK)

(72) Inventors: Lars-Mikkel MØRUP-PETERSEN, Støvring (DK); Peter Agerbo LANNG, Støvring (DK)

(21) Appl. No.: 18/838,744

(22) PCT Filed: Feb. 13, 2023
(86) PCT No.: PCT/EP2023/053469

§ 371 Date: Aug. 15, 2024

(30) Foreign Application Priority Data
Feb. 15, 2022 (EP) 22156873.6

(51) Int. Cl. B66B 9/08; E04F 11/00; E04F 11/025; E04F 11/18

(52) U.S. Cl. CPC B66B 9/0869; E04F 11/002; E04F 11/0255; E04F 11/181; E04F 2011/005

(57) ABSTRACT

The invention relates to a lifting system (1) for a stairway, wherein said lifting system can take at least two positions: a stairway position and a platform lift position. The lifting system is provided with a rotatable ramp (9) for enabling a walking-impaired person to enter or exit the lifting system, when the lifting system is in a platform lift position, said ramp being rotatable mounted along at least a part of an outermost edge of the step (2, 3). Furthermore, the invention relates to a method of operating a lifting system, wherein the operation transforms the lifting system from a stairway position to a platform lift position to enabling a walking-impaired person and/or an aid for a walking-impaired person to get from a lower level to an upper level or to get from an upper level to a lower level. Moreover, the invention relates to a computer program.

### FIELD OF THE INVENTION

The present invention relates to a lifting system for a stairway, wherein said lifting system can take at least two positions: a stairway position and a platform lift position. The lifting system is provided with a rotatable ramp for enabling a walking-impaired person to enter or exit the lifting system, when the lifting system is in a platform lift position. Furthermore, the present invention relates to a method of operating a lifting system, wherein the operation transforms the lifting system from a stairway position to a platform lift position to enable a walking-impaired person to get from a lower level to an upper level or to get from an upper level to a lower level.

### BACKGROUND OF THE INVENTION

In modern buildings, a significant problem posing a challenge to an architect is the connection between different levels in the building. The connections have to facilitate transportation of people that are not able to use regular stairways or only with great difficulty, e.g. physically impaired people using wheelchairs or parents with children in perambulators. The number of possibilities of lifting people is many, but they all involve considerable drawbacks.

A first solution may be the use of an ordinary elevator, which has the advantage of being capable of transporting all kinds of persons and their goods and chattels. However, the disadvantages of an elevator is the expensiveness and the extra space an elevator takes up if installed in a building.

A second solution is to use an ordinary platform lift, however the same disadvantages as for elevators with the need of extra space in the building emerges.

A third solution, illustrated in EP 1 600 416 A1, is to provide a lifting system, wherein a stairway can be transformed into a lift.

However, a significant problem and disadvantages for the lifting system illustrated in EP 1 600 416 A1 and known in the marked may be that the entering and leaving/exiting of the lifting system may be inconvenient and uncomfortable for the walking-impaired person due to a steep ramp, especially for wheelchair users.

Hence, an improved lifting system would be advantageous, and in particular a more efficient, reliable and/or convenient lifting system would be advantageous.

### OBJECT OF THE INVENTION

In particular, it may be seen as an object of the present invention to provide a lifting system that solves the above mentioned problems of the prior art.

It is a further object of the present invention to provide an alternative to the prior art.

### SUMMARY OF THE INVENTION

Thus, the above described object and several other objects are intended to be obtained in a first aspect of the invention by providing a lifting system for a stairway, said lifting system comprising:
at least one step of a first type,
at least one step of a second type,
   said first type of step and second type of step being provided displaceable in relation to each other,
lifting means,
at least one baluster,
at least two side pieces, extending from the proximate end of the stairway to the distant end of the stairway,
at least one banister, extending from a proximate end of the stairway to a distant end of the stairway,
   wherein said lifting system can take at least two positions:
a stairway position
a platform lift position
   wherein the lowermost step of the stairway is provided with a rotatable ramp for at least enabling a walking-impaired person and/or an aid for a walking-impaired person to enter or exit the lifting system, when the lifting system is in a platform lift position, and
   wherein said ramp is rotatable along at least a part of an outer edge of the step.

The invention is particularly, but not exclusively, advantageous for obtaining a lifting system, wherein the lifting system ensures a safe, comfortable and convenient entering or leaving/exiting of the platform of the lifting system via the ramp. The ramp is constructed and designed so that an aid, such as a wheelchair or perambulators, without any trouble and without an inconvenience for the wheelchair user can enter and/or leave the platform of the lifting system. Moreover, the invention provides a construction that due to its design and the solutions provided is a safe lifting system, which provides a safe lifting function. Furthermore, the invention may also be to provide a lifting system that is steady and self-supporting and still requires the lowest possible number of simple, lightweight and easy to assemble elements.

In the context of the invention, the “lifting means” may be understood as being one or more lifting means, such as actuators. The one or more lifting means can be the same, or it can be different types of lifting means/actuators. Preferably, four actuators are providing in the lifting system.

In the context of the invention, “the first type of step” may be understood as the steps, wherein a lifting means is penetrating, positioned or attached to.

In the context of the invention, “the second type of step” may be understood as the steps, wherein no lifting means is penetrating, positioned or attached to.

In an embodiment of the invention, the lifting system is a self-supporting lifting system.

In an embodiment, the lifting system further comprises:
said at least one second type of step being pivotally joined at first swivel joints to the two sidepieces of the stairway, and/or
said at least one baluster being pivotally joined to the banister at second swivel joints in the proximity of the upper end of said at least one baluster, and/or
each of said two sidepieces being pivotally hinged to said lifting means at third swivel joints in the proximity of distant ends of said two sidepieces, and/or
said at least one step of the first type being fixed to at least one lifting means for raising and lowering at least one first type of step, wherein activating said lifting means provides a raising or a lowering of said at least one first type of step and hereby a raising or lowering of said at least one second type of step.

The embodiment is particularly, but not exclusively, advantageous for obtaining a reliable and effective stairway lifting system.

In an embodiment of the invention, the rotatable ramp is positioned underneath the step that said ramp is mounted on, when the lifting system is in a stairway position, wherein the rotatable ramp preferably is in an at least substantially horizontal position.

Within the context of the invention, “underneath” may be understood as down under, under, below, beneath, and the like. Also, it should be understood that the ramp is positioned underneath the area of the step.

Within the context of the invention and specifically the embodiment of the ramp positioned underneath the step, the wording “substantially horizontal” should not be understood as an extremely limiting definition. The definition may be understood as “closer to horizontal than to vertical”, such that an angle on 22 degrees from completely horizontal is within the definition as substantially horizontal, wherein an angle of 0 degrees would be absolute horizontal.

The embodiment is particularly, but not exclusively, advantageous for obtaining a position of the ramp, so that it has a maximum level of safety and comfort for the user to use.

Furthermore, the position of the ramp is most reliable and effective construction wise, when being positioned underneath the step, preferably being the lowermost positioned first type of step.

Also, the position makes is easy to adjust the position of the ramp.

Moreover, when the ramp is being positioned at the lowermost step, the ramp is easy to access and thereby easy and safe to maintain, to provide service for and to attach/detach.

If the ramp was not hidden underneath the step, while the lifting system takes a stairway position, the ramp could be a danger or risk for the surrounding, such as if someone strikes the foot into it, or a child falls into it.

In an embodiment of the invention, the rotatable ramp is in an at least substantially horizontal position, when being positioned underneath the step that the ramp is mounted on.

The embodiment is particularly, but not exclusively, advantageous for obtaining a ramp that when not being in use is hidden underneath the step, which makes the ramp safe and secure for the surroundings. No sharp edges or corners are protruding unnecessarily.

Also, the substantially horizontal position makes the ramp substantially invisible, when not in use (lifting system in stairway position).

In an embodiment of the invention, the rotatable ramp is at least substantially aligned with the step being mounted on and not being accessible from at least the front or from the top of the stairway, when being positioned underneath a lowermost step, preferably the ramp is substantially invisible from at least the side-view, from the front-view and from the top-view, when being positioned underneath the step.

The embodiment is particularly, but not exclusively, advantageous for obtaining a ramp that when not in use is hidden underneath the step, which makes the ramp safe and secure for the surroundings. No sharp edges or corners are protruding unnecessarily.

In an embodiment of the invention, the rotatable ramp takes a ramp position, wherein the ramp is folded out and encounters the floor with at least the outer edge and act as a ramp, when the lifting system takes a lowermost platform lift position.

The embodiment is particularly, but not exclusively, advantageous for obtaining an easy and comfortable entering or leaving for a person in a wheelchair, since no steep edge or ramp will be present.

In an embodiment of the invention, the rotatable ramp takes a substantially vertical position and acts as a barrier, at least when said lifting system is moving up or down in a platform position.

The embodiment is particularly, but not exclusively, advantageous for obtaining a safe and secure lifting system, wherein the ramp does not only have an ordinary ramp purpose, but can fulfil several purposes, such as both acting as a ramp and as a safety barrier, preventing a wheelchair from rolling off during operations.

Within the context of the invention and specifically the embodiment of the ramp positioned as a barrier, the wording “substantially vertical” should not be understood as an extremely limiting definition. The definition may be understood as “closer to vertical than to horizontal”, such that an angle on 90-110 degrees, such as 94 degrees, is within the definition of substantially vertical, wherein absolute vertical would be an angle on 90 degrees.

In an embodiment of the invention, the rotatable ramp can take at least three positions:
1) a hidden position underneath the step that said ramp is mounted on, when the lifting system takes a stairway position, wherein the rotatable ramp preferably is in an at least substantially horizontal position
2) a ramp position, wherein the ramp is folded out and encounters the floor with the outer edge and act as a ramp, when the lifting system takes a lowermost platform lift position,
3) a barrier position, wherein the ramp takes a substantially vertical position and act as a barrier, when said lifting system is moving up or down in a platform lift position.

The embodiment is particularly, but not exclusively, advantageous for obtaining a lifting system, wherein the ramp does not only have one purpose, but can fulfil several purposes, such as both acting as a ramp, as a safety barrier and as a hidden object, when not in use.

If the ramp was not hidden underneath the step, while the lifting system takes a ramp position, the ramp could be a danger or risk for the surroundings, such as if someone strikes the foot into it, or a child falls into it.

In an embodiment of the invention, the ramp comprises at least one supporting structure, preferably two, underneath the ramp, wherein the supporting structure encounters the floor, when outermost edge of the ramp encounters the floor, preferably said one or two supporting structures are positioned substantially underneath the two side ends of the ramp.

The embodiment is particularly, but not exclusively, advantageous for obtaining a ramp structure being the most sufficient, durable, and has the most carrying strength. A person in a wheelchair often has a total weight being rather high, and to ensure that the ramp will never start to deform, such as bending, either during use or over time, the supporting structures of the ramp makes sure, that the ramp can withstand the weight, also over time after many wheelchair or other objects has rolled over the ramp.

In an embodiment of the invention, the ramp has a rectangular shape.

In an embodiment of the invention, the ramp has a trapezoidal shape.

The embodiment is particularly, but not exclusively, advantageous for obtaining a ramp, wherein the innermost edge of the ramp can be the same as the width of the step, and still allows, that the ramp will not encounter the actuators, when being in an hidden position underneath the step, since the trapezoidal shape enables the ramp to pass the actuators, due to the reduced width of the outermost edge of the ramp.

The areal of the ramp area is thereby made as big as possible, while still enabling the ramp to pass the actuators, when the ramp is in a hidden position underneath the step.

In an embodiment of the invention, the ramp has at least one edge being:
at least 85% of the width of the step that said ramp is mounted on, preferably substantially the same width as the step that said ramp is mounted on.

The embodiment is particularly, but not exclusively, advantageous for obtaining a ramp having the biggest area as possible, and thereby making the entering and leaving the lift the easiest and most convenient for the users.

A preferred width of the step is between 700-1200 mm, however this interval should not be seen as limiting for the width of the step within the context of the invention.

In an embodiment of the invention, the rotatable ramp is formed in one rigid piece.

Within the context of the invention, it may be understood that “one rigid piece” is defining that the ramp alone is in one piece. However, it should be understood within the context of the invention that there are surrounding extra parts of the ramp, such as ramp pipe/tube, the motor (lifting means), locking components, the potential supporting structures etc., which are not being comprised in the understanding of a “one-part ramp”.

The embodiment is particularly, but not exclusively, advantageous for obtaining a ramp being a secure and reliable ramp, since the one-piece ramp is a very strong, solid, resilient and robust construction. There will be no weak and unreliable spots on the ramp, when the ramp is made as a one-piece ramp, and thereby the risk of breaking is not existing.

In an embodiment of the invention, the rotatable ramp is made of metal, preferably steel or aluminium, or made of polymer, preferably plastic.

The embodiment is particularly, but not exclusively, advantageous for obtaining a strong, solid, resilient and robust construction of a ramp.

In an embodiment of the invention, the rotatable ramp has a length being at least the half of the depth of the step that said ramp is mounted on.

Within the context of the invention, the “depth of the step” might also be understood as the “run” of the step or the like.

The embodiment is particularly, but not exclusively, advantageous for obtaining a ramp with an elongated length according to already known ramp systems.

The longer the length of the ramp is dimensioned, the better, since the angle between the floor and the ramp (slope degree) decreases when the length of the ramp increases.

The smaller the angle between the floor and the ramp is, the more comfortable and convenient is it for a user to enter or leaving the lifting system via the ramp, since a steep angle is uncomfortable for a wheelchair user to pass.

A preferred minimum length of the ramp is 130 mm, however this minimum should not be seen as limiting for the length of the ramp within the context of the invention.

A preferred length of the ramp is between 150-250 mm, however this interval should neither be seen as limiting for the length of the ramp within the context of the invention.

In an embodiment of the invention, the rotatable ramp has a length being at least two thirds of the depth of the step that said ramp is mounted on.

The embodiment is particularly, but not exclusively, advantageous for obtaining a ramp being even more comfortable and convenient for a user to enter or leaving the lifting system via, since the angle between the floor and the ramp (slope degree) decreases when the length of the ramp increases.

In an embodiment of the invention, the ramp has a length being longer than the height between the floor and the step that said ramp is mounted on.

The embodiment is particularly, but not exclusively, advantageous for obtaining a lift with a ramp being as long as possible, and thereby a ramp being the most comfortable and convenient for a user to enter or leaving the lifting system via. In an embodiment of the invention, the rotatable ramp is folded out to an unfolded position, when the lifting system is in a platform lift position, wherein the ramp forms an angle relative to the horizontal floor, said angle being 18 degrees or less, preferably being between 12-17 degrees, and most preferably being below 12 degrees, such as 11, 10, 9, 8, 7 degrees, or even less.

The embodiment is particularly, but not exclusively, advantageous for obtaining a ramp with an elongated length, so that the angle between the floor and the ramp (slope degree) can be decreased. The longer the length of the ramp is dimensioned, the better, since the angle between the floor and the ramp decreases when the length of the ramp increases.

In an embodiment of the invention, the ramp comprises an angled portion along the outermost edge of the ramp.

The embodiment is particularly, but not exclusively, advantageous, since the angled portion of the ramp ensures that there is a smooth transition between the ramp and the floor.

Thereby, the embodiment provides an even more secure and comfortable for the wheelchair user, when leaving or entering the platform via the ramp.

Within the context of the invention, the “angled portion” may be understood as an inclined portion or oblique portion, or the like.

In an embodiment of the invention, the ramp is rotatable fixed along at least 80% of the step, preferably being mounted along 85-90%, most preferably being mounted along substantially the entire width, and preferably being mounted to the front edge of the step.

The embodiment is particularly, but not exclusively, advantageous for obtaining a strong, effective and reliable construction and attachment of the ramp to the rest of the lifting system. If the ramp is attached along the entire width of the step, the maximum strength of the attachment is obtained.

In the context of the invention, “fixed” may be understood as “attached” or “fasten” or “secured” or the like. In addition, the fixation/attachment may within the context of the invention be either directly or indirectly. Moreover, “fixed” may preferably be understood as movably fixed.

In the context of the invention, it may be understood that “the entire width” should be understood as “substantially the entire width”, since due to the way of constructing the fixation/attachment small part of the ramp may not be fixed to the step. As an example, minor part of the ends of the ramp may not be fixed to the step, or smaller part along the width may not be fixed, such as if the attachment is made in a plurality of smaller attachment parts instead of one coherent attachment part, as preferred.

In an embodiment of the invention, the lifting system comprises safety measures, such as:
a safety plate at one or two of the ends (top/bottom) of lifting system, and/or
safety bars at one or two of the ends (top/bottom) of the lifting system, and/or
any other suitable safety measures,
   wherein the safety measures preferably are automatically activated, when the lifting means of the system is activated.

In an embodiment of the invention, at least one of the first type of steps and/or at least one of the second type of steps comprises a first detection means at an underside of the step for detection of any objects obstructing the steps from being lowered or raised.

The embodiment is particularly, but not exclusively, advantageous for obtaining a lifting system being safe and secure for the surroundings. If an object, such as a child, for some reason is located below the stairway, the stairway will immediately detect the child (or other object) at the slightest touch and automatically stop moving the lifting system in any direction. Thereby, the lifting system will never be a safety-problem for any person or object located underneath the system.

In an embodiment of the invention, the first type of steps and the second type of steps comprises an outer frame made of metal, and wherein the part of the step being framed can be another material, such as wood, plywood, polymer, laminate, linoleum or another type of metal.

The embodiment is particularly, but not exclusively, advantageous for obtaining a lifting system, wherein the steps of the lifting system can be designed to always blend well into the surroundings and thus fit perfectly into the surroundings.

In an embodiment of the invention, one of the first type of step is provided in each end of the sidepieces and the lifting means is hinged to the sidepieces in both ends, and at least one of the second type of steps is further provided along the sidepieces so as to provide a platform formed by the steps, when said lifting means in both ends of the sidepieces is raised or lowered to a level being equal in both of said ends.

In an embodiment of the invention, the lifting system further comprising a control means being provided for receiving input from a user and being connected to the lifting means, said control means being capable of activating the lifting means according to user input and at the same time controlling the lifting means to be lowered only when clear signals are received from the first detection means.

The invention further relates to a second aspect of the invention, being method of operating a lifting system, wherein the operation transforms the lifting system from a stairway position to a platform lift position to enable a walking-impaired person and/or an aid for a walking-impaired person to get from a lower level to an upper level, the method comprising the steps of:
activating the lifting system to start lowering steps of the stairway, by activating at least one lifting means, preferably a set of two lifting means,
lowering the steps to a predetermined level,
raising the system to a predetermined height to allow a ramp to be folded out without encountering an associated floor,
unfolding a ramp by rotating the ramp from underneath the lowermost step of the stairway,
continuing lowering the steps of the stairway to a predetermined lowermost level, wherein all the steps are in a horizontal plane forming a platform,
ensuring at least the outermost edge of the ramp encounters the floor to allow the user to enter the platform via the ramp, by rotating the ramp,
activating the lifting system,
rotating the ramp up to an at least substantially vertical position to form an exit barrier for the user,
raising the platform to an upper level and allow the user to leave the platform, and
optionally, converting the lifting system from a platform lift position into stairway position, wherein during the conversion, the ramp is rotated down under the step, or
optionally, lowering the platform to a lower level to help another person to get from one level to another, wherein the ramp is rotated from a barrier position to a ramp position,
   wherein the steps can be performed in any order, subsequently and/or simultaneously.

This second aspect of the invention is particularly, but not exclusively, advantageous in that it allows a lifting system to comprise an elongated ramp, preferably in one piece, and to fold in and out the elongated ramp without encountering the floor. The method further provides an effective, reliable safe and secure method of enabling a walking-impaired person and/or an aid for a walking-impaired person to get from a lower level to an upper level.

In the context of the invention, the steps of “activating” may be understand as a manual/non-automatic action may be done. The manual action could be such as the press/push/hold of a button on a control panel, such as a remote control or an integrated control box/panel.

In the context of the invention, it may be understood, that when “activating” the lifting system, one or more lifting means, such as actuators, may be activated and/or the rotation of the ramp of the lifting system may be activated.

Other things that may be activated are safety means, such as:
a safety plate at one or two of the ends (top/bottom) of the lifting system, and/or
safety bars at one or two of the ends (top/bottom) of the lifting system, and/or
any other suitable safety measures.

The activation of the above examples (lifting means, ramp rotation, safety means, and/or more) may be activated at the same time or may be activated subsequent of each other.

“Raising the system to a predetermined height to allow a ramp to be folded out without encountering an associated the floor” may be understood as at least a part of the lifting system is raised to a predetermined height to allow a ramp to be folded out without encountering an associated floor, or at least the lowermost step of the lifting system is raised to a predetermined height to allow a ramp to be folded out without encountering an associated floor.

In an embodiment of the invention, the method further comprises the step of lowering the platform of the lift down to a lower level to help another person to get from one level to another,
activating the lifting system to start lowering steps of the lifting system, by activating at least one lifting means, preferably a set of two lifting means,
lowering the steps to a predetermined level,
rotating the ramp from a barrier to a ramp position
continuing lowering the steps of the stairway until a predetermined lowermost level, wherein all the steps are in a horizontal plane forming a platform,
ensuring at least the outer edge of the ramp encounters the floor to allow the user to drive onto the platform via the ramp, by rotating the ramp,
activating the lifting system,
rotating the ramp up to an at least substantially vertical position to form an exit barrier for the user,
raising the platform to an upper level and allow the user to leave the platform.

In an embodiment of the invention, the method further comprises the step of detecting, preferably with detecting means, any objects obstructing the steps from being lowered or raised.

The embodiment is particularly, but not exclusively, advantageous for obtaining a method of a lifting system being safe and secure for the surroundings. If an object, such as a child, for some reason is located below the stairway, the stairway will immediately detect the child (or other object) at the slightest touch and automatically stop moving the lifting system in any direction. Thereby, the lifting system will never be a safety-problem for any person or object located underneath the system.

The invention further relates to a third aspect of the invention, being a method of operating a lifting system, wherein operation transforms the lifting system from a stairway position to a platform lift position to enable a walking-impaired person and/or an aid for a walking-impaired person to get from an upper level to a lower level, the method comprising the steps of:
activating a lifting system to start lowering steps of the stairway, by activating at least one lifting mean,
lowering the steps to a predetermined level,
raising the system to a predetermined height to allow a ramp to be folded out without encountering an associated floor,
unfolding a ramp by rotating the ramp from underneath the lowermost step of the stairway to an at least substantially vertical position to form an exit barrier for the user,
continuing lowering at least one step to a predetermined level until all the steps are in a horizontal plane forming a platform,
raising the platform,
allowing the user to enter the platform,
activating the lifting system to start lowering the platform to a predetermined lowermost level, by activating at least one lifting means,
ensuring at least the outermost edge of the ramp encounters the floor to allow the user to leave the platform via the ramp, by rotating the ramp,
optionally, converting the lifting system from a platform lift position into a stairway position, wherein during the conversion, the ramp is rotated down under the step, or
optionally, raising the platform to an upper level to help another person to get from one level to another, wherein the ramp is rotated from a ramp position to a barrier position,
   wherein the steps can be performed in any order, subsequently and/or simultaneously.

This third aspect of the invention is particularly, but not exclusively, advantageous in that it allows a lifting system to comprise an elongated ramp, preferably in one piece, and to fold in and out the elongated ramp without encountering the floor. The method further provides an effective, reliable safe and secure method of enabling a walking-impaired person and/or an aid for a walking-impaired person to get from a lower level to an upper level.

Furthermore, the step of “continuing lowering the steps to a predetermined level until all the steps are in a horizontal plane forming a platform” provides the effect of synchronizing the actuators.

In the context of the invention, the steps of “activating” may be understand as a manual/non-automatic action may be done. The manual action could be such as press/push a bottom on a control panel, such as a remote control or an integrated control box.

In the context of the invention, is may be understood, that when activating the lifting system, one or more lifting means, such as actuators, are activated.

In an embodiment of the invention, the method further comprises the steps of raising the platform of the lift up to an upper level to help another person to get from one level to another, wherein
activating the lifting system to start raising the platform, by activating at least lifting means,
rotating the ramp from a ramp to a barrier position, and
raising the platform to an upper level and allow the user to leave the platform.

In an embodiment of the invention, the method further comprises the step of detecting, preferably with detecting means, any objects obstructing the steps from being lowered or raised.

The embodiment is particularly, but not exclusively, advantageous for obtaining a method of a lifting system being safe and secure for the surroundings. If an object, such as a child, for some reason is located below the stairway, the stairway will immediately detect the child (or other object) at the slightest touch and automatically stop moving the lifting system in any direction. Thereby, the lifting system will never be a safety-problem for any person or object located underneath the system.

In an embodiment of the invention the method may be done by a more simple operation, wherein the method of operating a lifting system, wherein the operation transforms the lifting system from a stairway position to a platform lift position to enable a walking-impaired person and/or an aid for a walking-impaired person to get from an upper level to a lower level, the method comprising the steps of:
activating a lifting system in a stairway position to start raising steps of the stairway, by activating at least one lifting means,
unfolding a ramp by rotating the ramp from underneath the lowermost step of the stairway to an at least substantially vertical position to form an exit barrier for the user,
raising the lifting system, when the lifting system is in a platform position, to an upper level allowing the user to enter the platform,
activating the lifting system to start lowering the platform to a predetermined lowermost level, by activating at least one lifting means,
ensuring at least the outermost edge of the ramp encounters the floor to allow the user to leave the platform via the ramp, by rotating the ramp,
optionally, converting the lifting system from a platform lift position into a stairway position, wherein during the conversion, the ramp is rotated down under the step, or
optionally, raising the platform to an upper level to help another person to get from one level to another, wherein the ramp is rotated from a ramp position to a barrier position,
   wherein the steps can be performed in any order, subsequently and/or simultaneously.

The invention further relates to a fourth aspect of the invention, being a computer program comprising instructions which, when the program is executed by a computer, cause the computer to carry out the method of the second and/or third aspect.

The first, second, third and fourth aspect of the present invention may each be combined with any of the other aspects. These and other aspects of the invention will be apparent from and elucidated with reference to the embodiments described hereinafter.

### BRIEF DESCRIPTION OF THE FIGURES

The lifting system and the methods for operating a lifting system according to the invention will now be described in more detail with regard to the accompanying figures. The figures show one way of implementing the present invention and is not to be construed as being limiting to other possible embodiments falling within the scope of the attached claim set.

FIG. 1A illustrates a lifting system for a stairway being in a stairway position.

FIG. 1B illustrates a lifting system for a stairway being in a platform lift position in the lowermost position.

FIG. 1C illustrates a lifting system for a stairway being in a platform lift position in the highest position.

FIG. 2A illustrates a lifting system for a stairway being in a stairway position.

FIG. 2B illustrates a lifting system for a stairway being in a platform lift position in the lowermost position.

FIG. 2C illustrates a lifting system for a stairway being in a platform lift position in the highest position.

FIG. 3A illustrates a ramp for a lifting system having a rectangular shape.

FIG. 3B illustrates a ramp for a lifting system having a trapezoidal shape.

FIG. 3C illustrates the dimension designations of the ramp length, of the step depth and of the height between the step and the floor.

FIG. 4 illustrates a first type of step and a ramp seen from a top view.

FIG. 5A illustrates a ramp being in a hidden position underneath the step that said ramp is mounted on, when the lifting system takes a stairway position.

FIG. 5B illustrates a ramp being a barrier position, wherein the ramp takes a substantially vertical position.

FIG. 5C illustrates a ramp in a ramp position, wherein the ramp is folded out.

FIG. 6A-F illustrate in 2D perspective from a side view the overall steps of a preferred method of operating a lifting system, wherein the operation transforms the lifting system from a stairway position to a platform lift position, with the overall purpose of getting a person in wheelchair from a lower level to an upper level.

FIG. 7A-F illustrate in 3D perspective the overall steps of a preferred method of operating a lifting system, wherein the operation transforms the lifting system from a stairway position to a platform lift position, with the overall purpose of getting a person in wheelchair from a lower level to an upper level.

FIG. 8A-H F illustrate in 2D perspective from a side view the overall steps of a preferred method of operating a lifting system, wherein the operation transforms the lifting system from a stairway position to a platform lift position, with the overall purpose of getting a person in wheelchair from an upper level to a lower level.

FIG. 9A-H illustrate in 3D perspective the overall steps of a preferred method of operating a lifting system, wherein the operation transforms the lifting system from a stairway position to a platform lift position, with the overall purpose of getting a person in wheelchair from an upper level to a lower level.

### DETAILED DESCRIPTION OF AN EMBODIMENT

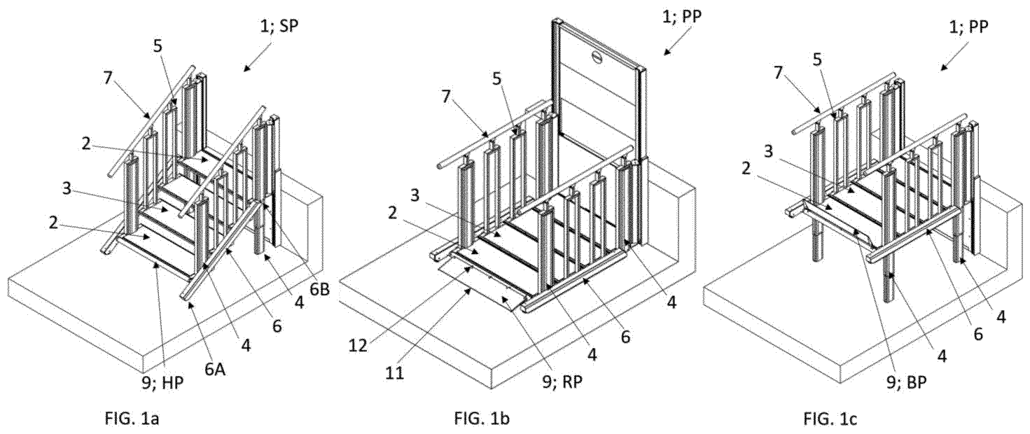

FIG. 1A illustrates a lifting system for a stairway being in a stairway position (SP). The lifting system (1) for a stairway being a self-supporting lifting system comprises:
At least one step of a first type (2), in FIG. 1 two steps of the first type is provided, being the two end steps.
At least one step of a second type (3), in FIG. 1 two steps of the second type is provided, being the two middle steps. Within the invention the lifting system can have from 1 to 10 or even 20 second type steps, or potentially even more.
   Said first type of steps (2) and second type of steps (3) being provided displaceable in relation to each other.
Lifting means (4), in FIG. 1 four lifting means is provided in the system, and said lifting means is illustrated as actuators.
At least one baluster (5), in FIG. 1 eight balusters are provided.
At least two side pieces (6), extending from the proximate end (6A) of the stairway to the distant end (6B) of the stairway, in FIG. 1 two side pieces are provided.
At least one banister (7), extending from a proximate end (6A) of the stairway to a distant end (6B) of the stairway, in FIG. 1 two banisters are provided.

Wherein said lifting system can take at least two positions: a stairway position (SP) or a platform lift position (PP), and in FIG. 1A the position illustrated is a stairway position.

Wherein the lowermost of the first type of steps (2) is provided with a rotatable ramp (9) for at least enabling a walking-impaired person and/or an aid for a walking-impaired person to enter or exit the lifting system, when the lifting system (1) is in a platform lift position, however in FIG. 1A the rotatable ramp is in a hidden position (HP), thereby being positioned underneath the lowermost first type of step, and wherein the rotatable ramp (9) preferably is in an at least substantially horizontal position. Within the invention, the ramp may also be mounted on the second type of step (3), however it is preferred to be the first type of step (2), that the ramp is mounted on.

Said ramp being rotatable mounted along at least a part of an outer edge of the first type of step, and in FIG. 1 the ramp is mounted along substantially the entire width of the step.

FIG. 1B illustrates a lifting system for a stairway, according to the description of the lifting system (1) described in FIG. 1A, however in FIG. 1B, the lifting system is in a platform lift position (PP) being in the lowermost position.

In FIG. 1B the rotatable ramp (9) takes a ramp position (RP), wherein the ramp is folded out and encounters the floor with at least the outermost edge (11) and act as a ramp, when the lifting system takes a lowermost platform lift position (PP). Furthermore, in FIG. 1B the lifting system comprises safety measures, illustrated as a safety plate at the top ends of lifting system. Within the invention other safety measures and other position of the safety measures are possible.

FIG. 1C illustrates a lifting system (1) for a stairway according to the description of the lifting system described in FIG. 1A, however in FIG. 1C, the lifting system is in a platform lift position (PP) being in the uppermost position.

In FIG. 1C the rotatable ramp (9) takes a substantially vertical position and acts as a barrier (barrier position, BP), when said lifting system is moving up or down in a platform position (PP).

FIG. 1A-C thereby illustrate a lifting system (1), wherein the rotatable ramp (9) can take at least three positions:
A hidden position (HP) underneath the step (2) that said ramp is mounted on, when the lifting system takes a stairway position (SP), wherein the rotatable ramp (9) preferably is in an at least substantially horizontal position.
A ramp position (RP), wherein the ramp (9) is folded out and encounters the floor with the outermost edge (11) and act as a ramp, when the lifting system takes a lowermost platform lift position (PP),
A barrier position (HP), wherein the ramp (9) takes a substantially vertical position and act as a barrier (BP), when said lifting system is moving up or down in a platform lift position (PP).

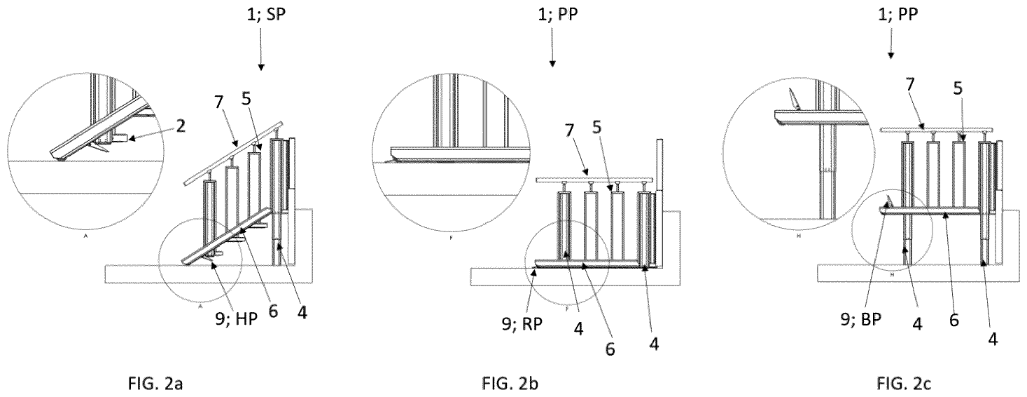

FIG. 2A illustrates a lifting system for a stairway being in a stairway position (SP) according to the description of FIG. 1A.

FIG. 2B illustrates a lifting system for a stairway being in a platform lift position (PP) in the lowermost position according to the description of FIG. 1B.

FIG. 2C illustrates a lifting system for a stairway being in a platform lift position (PP) in the highest position according to the description of FIG. 1C.

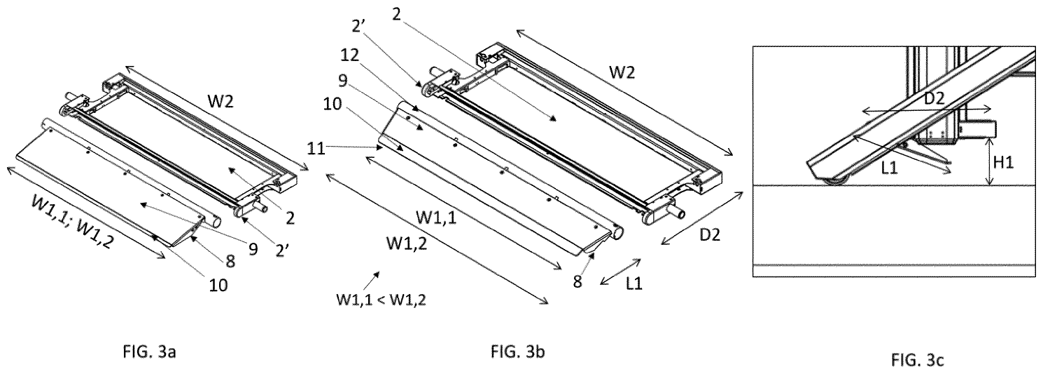

FIG. 3A illustrates a ramp (9) for a lifting system (1), wherein the ramp takes a rectangular shape, wherein the outermost width of the ramp (W1,1) is equal to the innermost width of the ramp (W1,2)→W1,1=W1,2

FIG. 3B illustrates a ramp (9) for a lifting system (1), wherein the ramp takes a trapezoidal shape, wherein the outermost width of the ramp (W1,1) is smaller than the innermost width of the ramp (W1,2)→W1,1<W1,2.

FIG. 3C illustrates the dimension designations of the ramp length (L1), the step depth (D2) and of the height between the step and the floor (H1).

FIG. 3A-B furthermore illustrate a ramp (9) having at least one edge (11,12) being at least 85% of the width of the step (W2) that said ramp is mounted on, preferably substantially the same width as the step that said ramp is mounted on.

Also, FIG. 3B illustrate one embodiment of fixing the ramp (9) to the step (2), wherein the rotatable ramp pipe/tube is directly fixed/attached to the two protruding portions (2′) of the step—This way of attaching the ramp should not be seen as limiting to the invention. Furthermore, it is illustrated that the ramp (9) is rotatable fixed along at least 80% of the step (2), more specifically being fixed along substantially the entire width (W2).

Moreover, the FIG. 3A-C illustrate a ramp (9) comprising an angled portion (10) along the outermost edge (11) of the ramp.

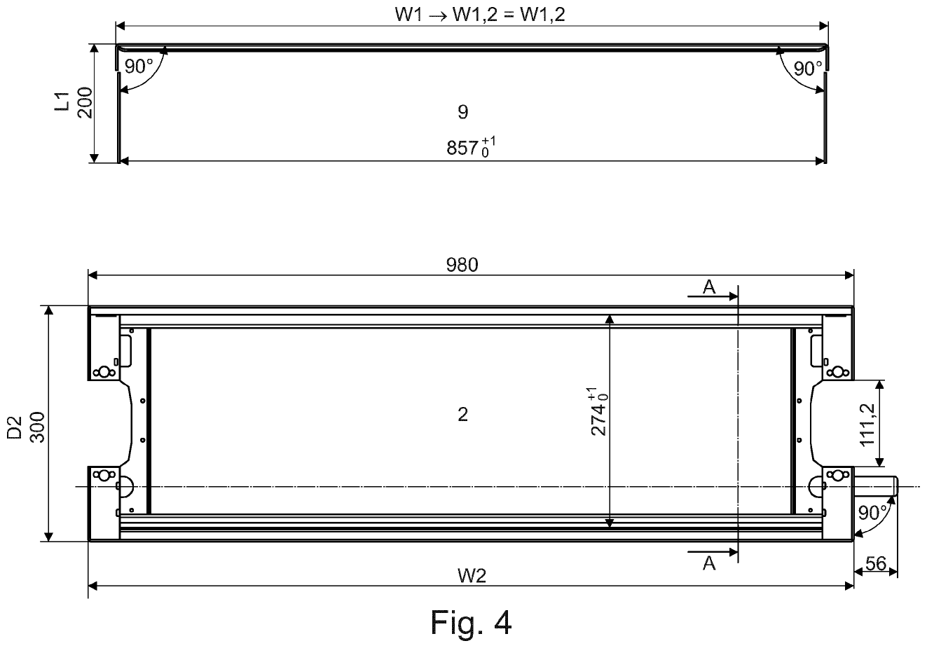

FIG. 4 illustrates a first type of step and a ramp (9) seen from a top view.

The rotatable ramp (9) has a length (L1) being two thirds of the depth (D2) of the first type of step that said ramp is mounted on.

Furthermore, the ramp has an edge being at least 85% of the width of the step that said ramp is mounted on, more specifically 87.5% ( 857/980*100).

Also, FIG. 4 illustrates that the ramp (9) has a width (W1) that allows the ramp to be rotated underneath the step (2) without encountering the actuators, which are to be positioned in the two notches of the step.

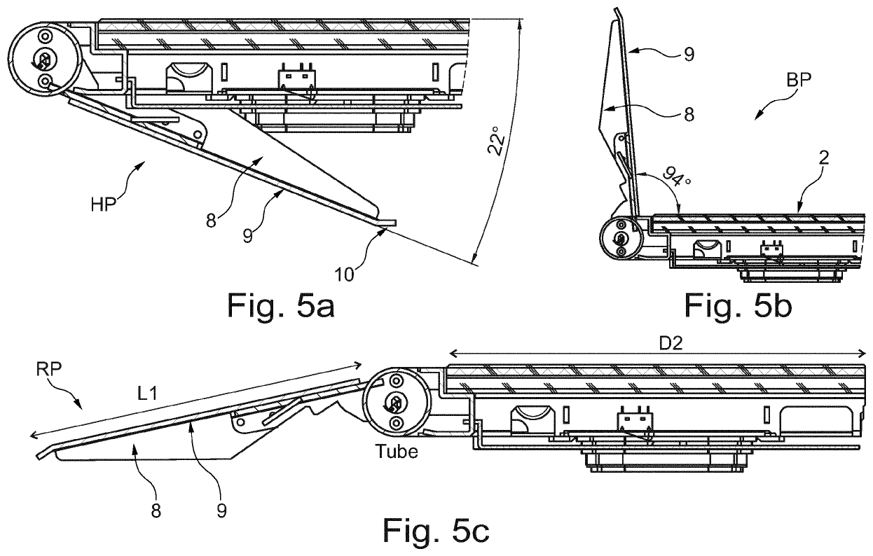

FIG. 5A illustrates a ramp (9) being in a position underneath the step (2) said ramp is mounted on, when the lifting system (1) takes a stairway position (SP). It is seen that the ramp has a position underneath the step being substantially horizontal, however not necessarily absolute horizontal. Within the invention the 22 degree illustrated as an example, is within the definition of substantially horizontal.

Furthermore, the supporting structures (8) of the ramp (9) is illustrated. Moreover, the ramp illustrated is fixed to the step via a tube, allowing the ramp to rotate.

FIG. 5B illustrates a ramp (9) being a barrier position (BP), wherein the ramp takes a substantially vertical position, and thereby is optimal for acting as a barrier. Within the invention the 94 degree illustrated as an example, is within the definition of substantially vertical.

FIG. 5C illustrates a ramp (9) in a ramp position (RP), wherein the ramp is folded out.

Furthermore, it is illustrated that the ramp (9) comprises at least one supporting structure (8), preferably two, underneath the ramp, wherein the supporting structure encounters the floor, preferably with an entire edge of the structure, when the outermost edge of the ramp encounters the floor, preferably said one or two supporting structures are positioned substantially underneath the two side ends of the ramp.

Moreover, the ramp (9) illustrated in FIG. 5C has a length (L1) being at least two thirds of the depth of the step (D2), in the figure the ramp has an even longer length than the preferred minimum of two thirds.

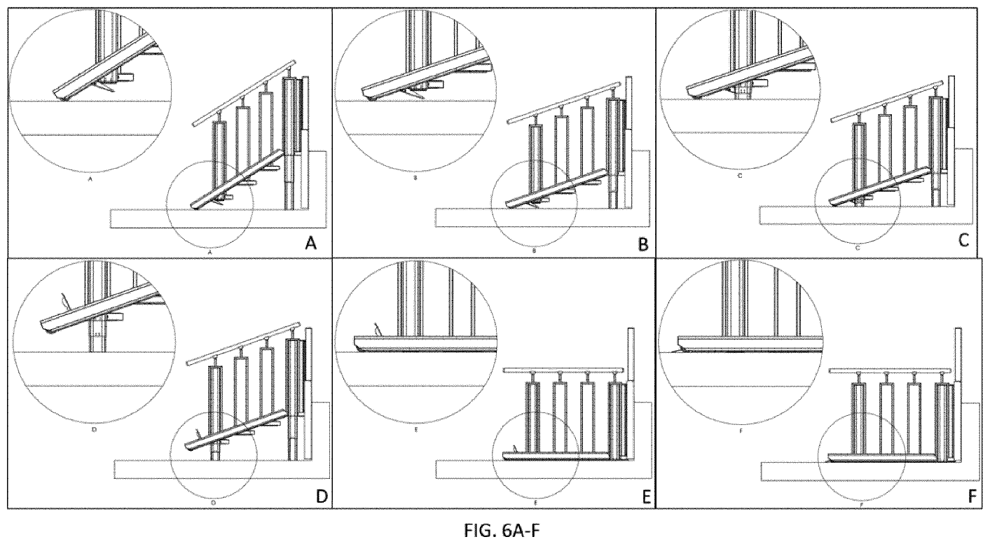

FIG. 6A-F illustrate in 2D perspective from a side view the overall steps of a preferred method of operating a lifting system (1), wherein the operation transforms the lifting system from a stairway position (SP) to a platform lift position (PP), with the overall purpose of getting a person in wheelchair from a lower level to an upper level.

The method comprising the steps of:
A: activating lifting system (1) to start lowering steps (2,3) of the stairway, by activating at least one lifting means (4), preferably a set of two lifting means,
B: lowering the steps (2,3) to a predetermined level,
C: at least one other lifting means is encountering the floor, preferably a set of two other lifting means encounters the floor,
D: raising the system (1) a predetermined height to allow a ramp (9) to be folded out without encountering the floor, and unfolding a ramp (9) by rotating the ramp from the lowermost step (2) of the stairway, preferably unfolding from underneath the step,
E: continuing lowering the steps (2,3) of the stairway to a predetermined lowermost level, wherein all the steps are in a horizontal plane forming a platform,
F: ensuring at least the outermost edge (11) of the ramp (9) encounters the floor to allow the user to enter the platform via the ramp, by rotating the ramp,
   wherein the steps can be performed in any order, subsequently and/or simultaneously.

The raising illustrated in FIG. 6D, is preferably resulting in a raising of the lifting system at about 100-300 mm above the floor, depending on the length (L1) of the ramp (9).

After the performance of the above described steps, the ramp (9) is rotated to a barrier position (BP) and the platform is raised to get a person in wheelchair from a lower level to an upper level—Thereby performing the steps of (not shown):
activating the lifting system (1), by activating at least lifting means (4),
rotating the ramp (9) up to an at least substantially vertical position to form an exit barrier for the user,
raising the platform to an upper level and allow the user to leave the platform.

After those steps, the method may comprise the steps (not shown):
optionally, converting the lifting system (1) from a platform lift position (PP) into stairway position, wherein during the conversion, the ramp (9) is rotated down under the lowermost step (2), or
optionally, lowering the platform of the lift down to a lowermost level to help another person to get from one level to another, wherein the ramp (9) is rotated from a barrier position (BP) to a ramp position (RP).

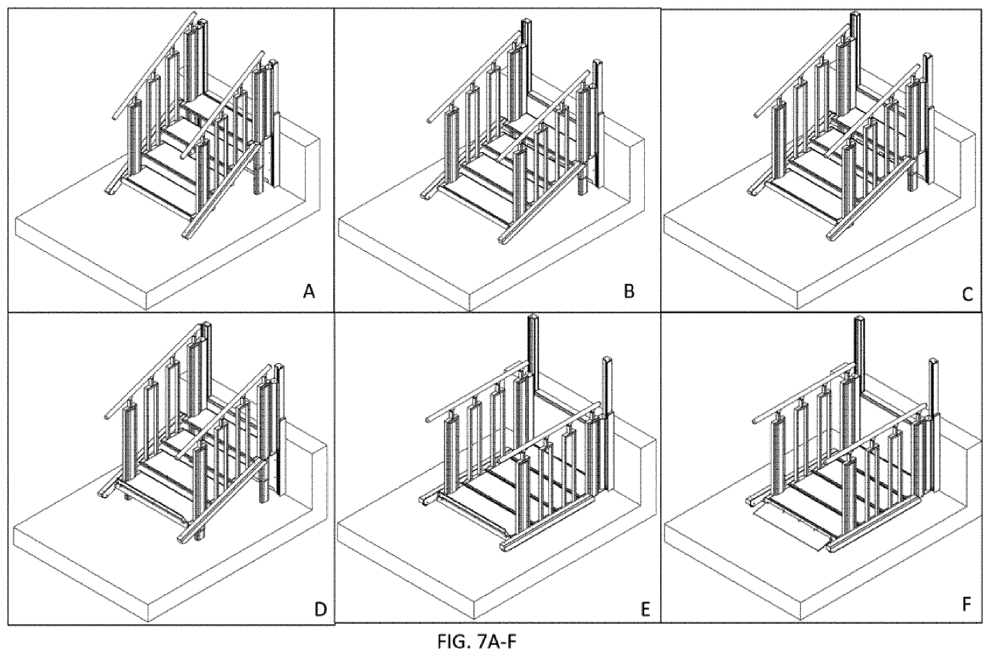

FIG. 7A-F illustrate in 3D perspective the overall steps of a preferred method of operating a lifting system (1), wherein the operation transforms the lifting system (1) from a stairway position (SP) to a platform lift position (PP) to get a person in wheelchair from a lower level to an upper level.

As descried for FIG. 6A-F the method comprising the same steps:
A: activating lifting system (1) to start lowering steps (2,3) of the stairway, by activating at least one lifting means (4), preferably a set of two lifting means,
B: lowering the steps (2,3) to a predetermined level,
C: at least one other lifting means is encountering the floor preferably a set of two other lifting means encounters the floor,
D: raising the system (1) a predetermined height to allow a ramp (9) to be folded out without encountering the floor, and unfolding a ramp (9) by rotating the ramp from the lowermost step (2) of the stairway, preferably unfolding from underneath the step,
E: continuing lowering the steps (2,3) of the stairway to a predetermined lowermost level, wherein all the steps are in a horizontal plane forming a platform,
F: ensuring at least the outermost edge (11) of the ramp (9) encounters the floor to allow the user to enter the platform via the ramp, by rotating the ramp,

Moreover, as also described for FIG. 6A-F, more steps might be performed and optional steps may be performed—See above.

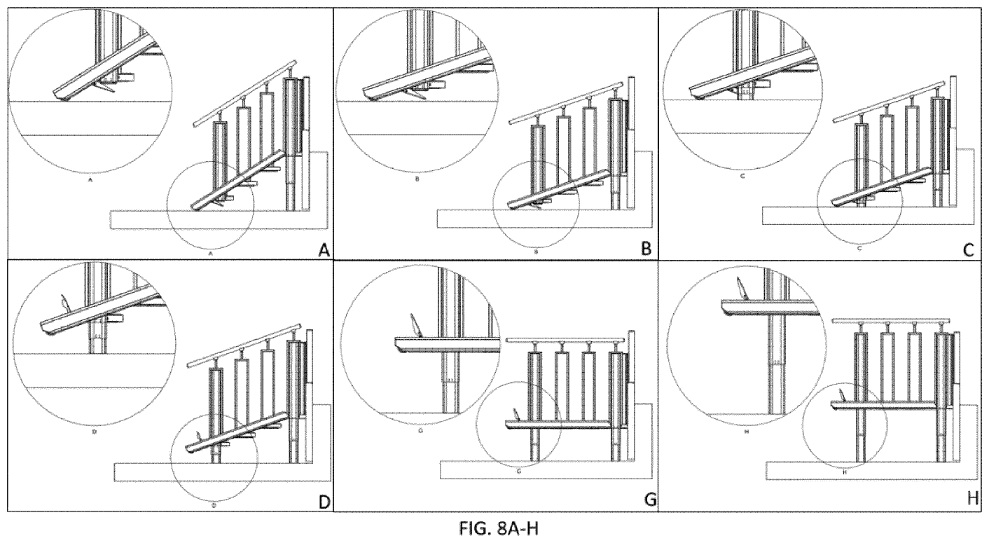

FIG. 8A-H illustrate in 2D perspective from a side view the overall steps of a preferred method of operating a lifting system (1), wherein the operation transforms the lifting system from a stairway position (SP) to a platform lift position (PP), with the overall purpose of getting a person in wheelchair from an upper level to a lower level.

The method comprising the steps of:
A: activating lifting system (1) to start lowering steps (2,3) of the stairway, by activating at least one lifting means (4), preferably a set of two lifting means,
B: lowering the steps (2,3) to a predetermined level,
C: at least one other lifting means is encountering the floor preferably a set of two other lifting means encounters the floor,
D: raising the system a predetermined height to allow a ramp (9) to be folded out without encountering the floor, and unfolding a ramp (9) by rotating the ramp from the lowermost step (2) of the stairway, preferably unfolding from underneath the step, to an at least substantially vertical position to form an exit barrier for the user,
G: continuing lowering at least one step (2,3) to a predetermined level until all the steps are in a horizontal plane forming a platform,
H: raising the platform
   wherein the steps can be performed in any order, subsequently and/or simultaneously.

After the performance of the above described and illustrated steps, the platform is lowered to get a person in wheelchair from an upper level to a lower level.

When the platform is in the lowermost position (PP), the ramp (9) will be rotated down to a ramp position encountering the floor—Thereby performing the steps of (not shown):
Allowing the user to enter the platform,
activating the lifting system (1) to start lowering the platform to a predetermined lowermost level,
ensuring at least the outermost edge of the ramp (11) encounters the floor to allow the user to leave the platform via the ramp, by rotating the ramp.

After those steps, the method may comprise the steps (not shown):
optionally, converting the lifting system (1) from a platform lift position (PP) into a stairway position (SP), wherein during the conversion, the ramp (9) is rotated down under the step, or
optionally, raising the platform of the lift up to an upper level to help another person to get from one level to another, wherein the ramp (9) is rotated from a ramp position (RP) to a barrier position (BP).

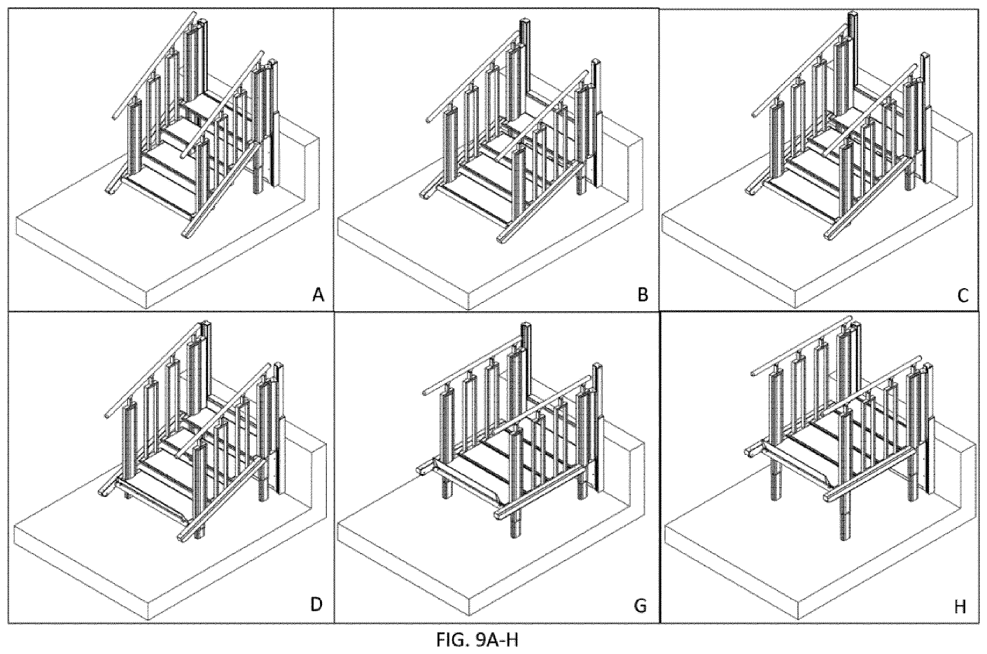

FIG. 9A-H illustrate in 3D perspective the overall steps of a preferred method of operating a lifting system (1), wherein the operation transforms the lifting system from a stairway position (SP) to a platform lift position (PP), with the overall purpose of getting a person in wheelchair from an upper level to a lower level.

As descried for FIG. 8A-G the method comprising the same steps:
A: activating lifting system (1) to start lowering steps (2,3) of the stairway, by activating at least one lifting means (4), preferably a set of two lifting means,
B: lowering the steps (2,3) to a predetermined level,
C: at least one other lifting means is encountering the floor, preferably a set of two other lifting means encounters the floor,
D: raising the system a predetermined height to allow a ramp (9) to be folded out without encountering the floor, and unfolding a ramp (9) by rotating the ramp from the lowermost step (2) of the stairway, preferably unfolding from underneath the step, to an at least substantially vertical position to form an exit barrier for the user,
G: continuing lowering at least one step (2,3) to a predetermined level until all the steps are in a horizontal plane forming a platform,
H: raising the platform

Moreover, as also described for FIG. 8A-H, more steps will be performed and optional steps may be performed—See above.

Although the present invention has been described in connection with the specified embodiments, it should not be construed as being in any way limited to the presented examples. The scope of the present invention is set out by the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

### REFERENCE OVERVIEW

Step of a first type (2)—may have protruding portions (2′)
Step of a second type (3)
Lifting means (4)
Baluster (5)
Side pieces (6)
   the proximate end (6A) of the stairway
   the distant end (6B) of the stairway,
Banister (7)
Supporting structure (8)
Rotatable ramp (9)
Angled portion (10) along the outermost edge of the ramp.
Outermost edge of the ramp (11)
Innermost edge of the ramp (12)
Stairway position (SP)
Platform lift position (PP)
Ramp position (RP)
Hidden position (HP)
Barrier position (BP)
Ramp length (L1)
Step depth (D2)
Height (H1) between the floor and the step
Ramp width (W1)
Outermost ramp width (W1,1)
Innermost ramp width (W1,2)
Step width (W2)

In exemplary embodiments E1-E15, the invention may relate to:
E1. A lifting system (1) for a stairway, said lifting system comprising:
   at least one step of a first type (2),
   at least one step of a second type (3),
      said first type of step (2) and second type of step (3) being provided displaceable in relation to each other,
   lifting means (4),
   at least one baluster (5),
   at least two side pieces (6), extending from the proximate end (6A) of the stairway to the distant end (6B) of the stairway,
   at least one banister (7), extending from a proximate end (6A) of the stairway to a distant end (6B) of the stairway,
wherein said lifting system can be configured for at least two positions:
   a stairway position (SP)
   a platform lift position (PP)
wherein the lowermost step of the stairway is provided with a rotatable ramp (9) for at least enabling a walking-impaired person and/or an aid for a walking-impaired person to enter or exit the lifting system (1), when the lifting system is in a platform lift position (PP), and
wherein said ramp (9) is rotatable along at least a part of an outer edge of the step, preferably said step being the first type of step (2).
E2. A lifting system (1) according to embodiment E1, wherein the rotatable ramp (9) is positioned underneath the step that said ramp is mounted on, when the lifting system is in a stairway position (SP), wherein the rotatable ramp (9) preferably is in an at least substantially horizontal position.
E3. A lifting system (1) according to embodiments E1-E2, wherein the rotatable ramp (9) takes a ramp position (RP), wherein the ramp is folded out and encounters an associated floor with at least the outermost edge (11) and act as a ramp, when the lifting system takes a lowermost platform lift position (PP).
E4. A lifting system (1) according to any of the preceding embodiments, wherein the rotatable ramp (9) takes a substantially vertical position and acts as a barrier (BP), when said lifting system is moving up or down in a platform position (PP).
E5. A lifting system (1) according to any of the preceding embodiments, wherein the rotatable ramp (9) can take at least three positions:
   a hidden position (HP) underneath the step (2,3) that said ramp (9) is mounted on, when the lifting system takes a stairway position (SP), wherein the rotatable ramp (9) preferably is in an at least substantially horizontal position,
   a ramp position (RP), wherein the ramp (9) is folded out and encounters an associated floor with the outermost edge (11) and act as a ramp, when the lifting system takes a lowermost platform lift position (PP),
   a barrier position (BP), wherein the ramp (9) takes a substantially vertical position and act as a barrier, when said lifting system is moving up or down in a platform lift position (PP).
E6. A lifting system (1) according to any of the preceding embodiments, wherein the ramp (9) comprises at least one supporting structure (8), preferably two, positioned underneath the ramp, wherein the supporting structure encounters an associated floor, when the outermost edge of the ramp (11) encounters the floor.
E7. A lifting system (1) according to any of the preceding embodiments, wherein the ramp (9) has a trapezoidal shape.
E8. A lifting system (1) according to any of the preceding embodiments, wherein the ramp (9) has at least one edge (11, 12) being:
   at least 85% of the width (W2) of the step that said ramp (9) is mounted on, preferably substantially the same width (W2) as the step that said ramp is mounted on.
E9. A lifting system (1) according to any of the preceding embodiments, wherein the rotatable ramp (9) has a length (L1) being at least two thirds of the depth (D2) of the step (2,3) that said ramp is mounted on.
E10. A lifting system (1) according to any of the preceding embodiments, wherein the ramp (9) has a length (L1) being longer than the height (H1) between the floor and the step (2,3) that said ramp is mounted on.
E11. A lifting system (1) according to any of the preceding embodiments, wherein the ramp (9) comprises an angled portion (10) along the outermost edge of the ramp (11).
E12. A lifting system (1) according to any of the preceding embodiments, wherein the ramp (9) is rotatable mounted along at least 80% of the width of the step (2,3), preferably being mounted along 85-90%, and more preferably being mounted along substantially the entire width (W2).
E13. A method of operating a lifting system (1), preferably according to any of the preceding embodiments, wherein the operation transforms the lifting system from a stairway position (SP) to a platform lift position (PP) to enable a walking-impaired person and/or an aid for a walking-impaired person to get from a lower level to an upper level, the method comprising the steps of:
   activating (S1) the lifting system (1) to start lowering steps of the stairway (SP), by activating at least one lifting means (4),
   lowering (S2) the steps (2,3) to a predetermined level,
   raising (S3) the system to a predetermined height to allow a ramp (9) to be folded out without encountering an associated the floor,
   unfolding (S4) a ramp (9) by rotating the ramp from underneath the lowermost step of the stairway,
   continuing lowering (S5) the steps (2,3) of the stairway to a predetermined lowermost level, wherein all the steps are in a horizontal plane forming a platform (PP),
   ensuring (S6) at least the outermost edge (11) of the ramp (9) encounters the floor to allow the user to enter the platform via the ramp, by rotating the ramp,
   activating (S7) the lifting system (1),
   rotating (S8) the ramp (9) up to an at least substantially vertical position to form an exit barrier for the user,
   raising (S9) the platform to an upper level and allow the user to leave the platform,
   optionally, converting (S101) the lifting system (1) from a platform lift position (PP) into stairway position (SP), wherein during the conversion, the ramp (9) is rotated down under the step (2,3), or
   optionally, lowering (S102) the platform to a lower level to help another person to get from one level to another, wherein the ramp (9) is rotated from a barrier position (BP) to a ramp position (RP),
wherein the steps can be performed in any order, subsequently and/or simultaneously.
E14. A method of operating a lifting system, preferably according to any of the preceding embodiments, wherein operation transforms the lifting system (1) from a stairway position (SP) to a platform lift position (PP) to enable a walking-impaired person and/or an aid for a walking-impaired person to get from an upper level to a lower level, the method comprising the steps of:
   activating (SS1) a lifting system (1) to start lowering steps of the stairway, by activating at least one lifting means (4),
   lowering (SS2) the steps (2,3) to a predetermined level,
   raising (SS3) the system to a predetermined height to allow a ramp (9) to be folded out without encountering an associated floor,
   unfolding (SS4) a ramp (9) by rotating the ramp from underneath the lowermost step (2,3) of the stairway to an at least substantially vertical position to form an exit barrier for the user,
   continuing lowering (SS5) at least one step (2,3) to a predetermined level until all the steps are in a horizontal plane forming a platform (PP),
   raising (SS6) the platform,
   allowing (SS7) the user to enter the platform,
   activating (SS8) the lifting system (1) to start lowering the platform to a predetermined lowermost level, by activating at least one lifting means (4),
   ensuring (SS9) at least the outermost edge (11) of the ramp (9) encounters the floor to allow the user to leave the platform via the ramp, by rotating the ramp,
   optionally, converting (SS101) the lifting system (1) from a platform lift position (PP) into a stairway position (SP), wherein during the conversion, the ramp (9) is rotated down under the step (2,3), or
   optionally, raising (SS102) the platform to an upper level to help another person to get from one level to another, wherein the ramp (9) is rotated from a ramp position (RP) to a barrier position (BP),
wherein the steps can be performed in any order, subsequently and/or simultaneously.
E15. A computer program comprising instructions which, when the program is executed by a computer, cause the computer to carry out the method of embodiment E13 and/or E14.

1. A lifting system (1) for a stairway, said lifting system comprising:
at least one step of a first type (2),
at least one step of a second type (3),
said first type of step (2) and second type of step (3) being provided displaceable in relation to each other,
lifting means (4),
at least one baluster (5),
at least two side pieces (6), extending from the proximate end (6A) of the stairway to the distant end (6B) of the stairway,
at least one banister (7), extending from a proximate end (6A) of the stairway to a distant end (6B) of the stairway,
wherein said lifting system can be configured for at least two positions:
a stairway position (SP)
a platform lift position (PP)
wherein the lowermost step of the stairway is provided with a rotatable ramp (9) for at least enabling a walking-impaired person and/or an aid for a walking-impaired person to enter or exit the lifting system (1), when the lifting system is in a platform lift position (PP),
wherein said ramp (9) is rotatable along at least a part of an outer edge of the step, preferably said step being the first type of step (2),
wherein the rotatable ramp (9) is positioned underneath the step that said ramp is mounted on, when the lifting system is in a stairway position (SP), wherein the rotatable ramp (9) preferably is in an at least substantially horizontal position, and
wherein the ramp (9) has a length (L1) being longer than the height (H1) between the floor and the step (2,3) that said ramp is mounted on.

2. A lifting system (1) according to claim 1, wherein the rotatable ramp (9) takes a ramp position (RP), wherein the ramp is folded out and encounters an associated floor with at least the outermost edge (11) and act as a ramp, when the lifting system takes a lowermost platform lift position (PP).

3. A lifting system (1) according to claim 1, wherein the rotatable ramp (9) takes a substantially vertical position and acts as a barrier (BP), when said lifting system is moving up or down in a platform position (PP).

4. A lifting system (1) according to claim 1, wherein the rotatable ramp (9) can take at least three positions:
a hidden position (HP) underneath the step (2,3) that said ramp (9) is mounted on, when the lifting system takes a stairway position (SP), wherein the rotatable ramp (9) preferably is in an at least substantially horizontal position,
a ramp position (RP), wherein the ramp (9) is folded out and encounters an associated floor with the outermost edge (11) and act as a ramp, when the lifting system takes a lowermost platform lift position (PP),
a barrier position (BP), wherein the ramp (9) takes a substantially vertical position and act as a barrier, when said lifting system is moving up or down in a platform lift position (PP).

5. A lifting system (1) according to claim 1, wherein the ramp (9) comprises at least one supporting structure (8), preferably two, positioned underneath the ramp, wherein the supporting structure encounters an associated floor, when the outermost edge of the ramp (11) encounters the floor.

6. A lifting system (1) according to claim 1, wherein the ramp (9) has a trapezoidal shape.

7. A lifting system (1) according to claim 1, wherein the ramp (9) has at least one edge (11, 12) being:
at least 85% of the width (W2) of the step that said ramp (9) is mounted on, preferably substantially the same width (W2) as the step that said ramp is mounted on.

8. A lifting system (1) according to claim 1, wherein the rotatable ramp (9) has a length (L1) being at least two thirds of the depth (D2) of the step (2,3) that said ramp is mounted on.

9. A lifting system (1) according to claim 1, wherein the ramp (9) comprises an angled portion (10) along the outermost edge of the ramp (11).

10. A lifting system (1) according to claim 1, wherein the ramp (9) is rotatable mounted along at least 80% of the width of the step (2,3), preferably being mounted along 85-90%, and more preferably being mounted along substantially the entire width (W2).

11. A method of operating a lifting system (1), according to claim 1, wherein the operation transforms the lifting system from a stairway position (SP) to a platform lift position (PP) to enable a walking-impaired person and/or an aid for a walking-impaired person to get from a lower level to an upper level, the method comprising the steps of:
activating the lifting system (1) to start lowering steps of the stairway (SP), by activating at least one lifting means (4),
lowering the steps (2,3) to a predetermined level,
raising the lowermost step of the lifting system to a predetermined height to allow a ramp (9) to be folded out without encountering an associated floor,
unfolding a ramp (9) by rotating the ramp from underneath the lowermost step of the stairway,
continuing lowering the steps (2,3) of the stairway to a predetermined lowermost level, wherein all the steps are in a horizontal plane forming a platform (PP),
ensuring at least the outermost edge (11) of the ramp (9) encounters the floor to allow the user to enter the platform via the ramp, by rotating the ramp,
activating the lifting system (1),
rotating the ramp (9) up to an at least substantially vertical position to form an exit barrier for the user,
raising the platform to an upper level and allow the user to leave the platform,
optionally, converting the lifting system (1) from a platform lift position (PP) into stairway position (SP), wherein during the conversion, the ramp (9) is rotated down under the step (2,3), or
optionally, lowering the platform to a lower level to help another person to get from one level to another, wherein the ramp (9) is rotated from a barrier position (BP) to a ramp position (RP).

12. A method of operating a lifting system, according to claim 1, wherein operation transforms the lifting system (1) from a stairway position (SP) to a platform lift position (PP) to enable a walking-impaired person and/or an aid for a walking-impaired person to get from an upper level to a lower level, the method comprising the steps of:
activating a lifting system (1) to start lowering steps of the stairway, by activating at least one lifting means (4),
lowering the steps (2,3) to a predetermined level,
raising the lowermost step of the lifting system to a predetermined height to allow a ramp (9) to be folded out without encountering an associated floor,
unfolding a ramp (9) by rotating the ramp from underneath the lowermost step (2,3) of the stairway to an at least substantially vertical position to form an exit barrier for the user,
continuing lowering at least one step (2,3) to a predetermined level until all the steps are in a horizontal plane forming a platform (PP),
raising the platform,
allowing the user to enter the platform,
activating the lifting system (1) to start lowering the platform to a predetermined lowermost level, by activating at least one lifting means (4),
ensuring at least the outermost edge (11) of the ramp (9) encounters the floor to allow the user to leave the platform via the ramp, by rotating the ramp,
optionally, converting the lifting system (1) from a platform lift position (PP) into a stairway position (SP), wherein during the conversion, the ramp (9) is rotated down under the step (2,3), or
optionally, raising the platform to an upper level to help another person to get from one level to another, wherein the ramp (9) is rotated from a ramp position (RP) to a barrier position (BP).

13. A computer program comprising instructions which, when the program is executed by a computer, cause the computer to carry out the method of claim 11.
